(19) United States
(12) Patent Application Publication
(10) Pub. No.: US 2010/0214585 A1
(43) Pub. Date: Aug. 26, 2010

(54) IMAGE PROCESSING APPARATUS, CONTROL METHOD, AND STORAGE MEDIUM

(75) Inventor: Masamichi Tanji, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/709,377

(22) Filed: Feb. 19, 2010

(30) Foreign Application Priority Data
Feb. 23, 2009 (JP) 2009-039174

(51) Int. Cl. G06K 15/02

(52) U.S. Cl. 358/1.12; 358/1.14; 358/1.15

(57) ABSTRACT

There is provided a control method for an image processing apparatus that is capable of discharging sheets printed based on print jobs input by a plurality of users to a lockable paper discharge unit, the control method including authenticating a user, releasing locking of the lockable paper discharge unit according to an authentication result, holding status information indicating whether each of the plurality of users who have discharged sheets to the lockable paper discharge unit is authenticated in a holding unit, determining whether there is any user who is not authenticated based on the status information held in the holding unit, detecting presence/absence of a sheet or sheets discharged to the lockable paper discharge unit, and notifying that an error has occurred in taking out of sheets if, after locking of the locked lockable paper discharge unit is released, absence of a sheet or sheets in the lockable paper discharge unit is detected and presence of a user who is not authenticated is determined.

### BACKGROUND OF THE INVENTION

1. Field of the Invention

The present invention relates to an image processing apparatus provided with a paper discharge unit, and in particular, relates to an image processing apparatus provided with a function to lock a paper discharge unit of the image processing apparatus, a control method, and a storage medium.

2. Description of the Related Art

When highly confidential data is printed, an image processing apparatus containing a printing apparatus conventionally has a function that retains print data in a storage apparatus inside the apparatus before a user comes to the front of the image processing apparatus and starts printing after the user comes to the image processing apparatus and performs an authentication operation.

However, with such a function alone, printing cannot be started unless the user actually comes to the front of the image processing apparatus and completes authentication (see, for example, Japanese Patent Application Laid-Open No. 2003-3081).

Thus, an image processing apparatus that has a plurality of paper discharge units and can lock these paper discharge units is known. When highly confidential or private data is printed, the user specifies a lockable paper discharge unit as a paper discharge destination in an image processing apparatus with such a configuration to discharge a printed product to the paper discharge unit. The image processing apparatus includes an authentication apparatus to authenticate the user and the user is authenticated by, for example, a card being held over the authentication apparatus by the user or a password being input. Then, if the authentication is successful, locking of the paper discharge unit corresponding to the authenticated user is released to provide the printed product to the user.

Accordingly, not only the discharged printed product can be prevented from being viewed by others, but also the need to wait in front of the apparatus before printing is completed can be eliminated.

Since such an image processing apparatus has a limited number of lockable paper discharge units, it is difficult in most cases to exclusively assign one lockable paper discharge unit to each user. Thus, a plurality of users in units of sections, for example, sometimes shares and uses one lockable paper discharge unit.

If printed products of a plurality of users are mixed in one lockable paper discharge unit, there is a possibility that a user who comes first takes all printed products away without being aware of mixing. In such a case, a situation occurs in which, when another user comes to take out a printed product later, there is no printed product to take out and the user does not know where the printed product is.

### SUMMARY OF THE INVENTION

According to an aspect of the present invention, an image processing apparatus that is capable of discharging sheets printed based on print jobs input by a plurality of users to a lockable discharging unit includes an authentication unit configured to authenticate the users, a locking control unit configured to release locking of the lockable paper discharge unit according to an authentication result by the authentication unit, a holding unit configured to hold status information indicating whether each of the plurality of users who have discharged sheets to the lockable paper discharge unit is authenticated by the authentication unit, a determining unit configured to determine whether there is any user who is not authenticated by the authentication unit based on the status information held by the holding unit, a detection unit configured to detect presence/absence of a sheet or sheets discharged to the lockable paper discharge unit, and a notification unit configured to notify that an error has occurred in taking out of sheets if, after locking of the locked lockable paper discharge unit is released by the locking control unit, the detection unit detects that there is no sheet in the lockable paper discharge unit and the determining unit determines that there is a user who is not authenticated by the authentication unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram exemplifying an image processing system including an image processing apparatus according to an exemplary embodiment of the present invention.

FIG. 2 is a sectional view illustrating an internal configuration of a multifunction peripheral illustrated in FIG. 1.

FIG. 3 is a block diagram illustrating the configuration of a controller illustrated in FIG. 1.

FIG. 4 is a diagram exemplifying a paper discharge destination management file managed by the multifunction peripheral illustrated in FIG. 1.

FIG. 5A is a diagram exemplifying a paper discharge unit information management file managed by the multifunction peripheral illustrated in FIG. 1.

FIG. 5B is a diagram exemplifying the paper discharge unit information management file managed by the multifunction peripheral illustrated in FIG. 1 and illustrates that a user has been authenticated.

FIG. 5C is a diagram exemplifying the paper discharge unit information management file managed by a multifunction peripheral illustrated in FIG. 1 and illustrates that there is no printed product remaining in a paper discharge unit.

FIG. 6 is a flow chart exemplifying a data processing procedure in the image processing apparatus according to an exemplary embodiment of the present invention.

FIG. 7 is a diagram exemplifying a user interface displayed on an operation unit illustrated in FIG. 3.

FIG. 8 is a diagram exemplifying a paper discharge unit history information management file managed by the multifunction peripheral illustrated in FIG. 1.

FIG. 9 is a flow chart exemplifying the data processing procedure in the image processing apparatus according to an exemplary embodiment of the present invention.

FIG. 10 is a diagram exemplifying the paper discharge unit history information management file managed by the multifunction peripheral illustrated in FIG. 1.

### DESCRIPTION OF THE EMBODIMENTS

Various exemplary embodiments, features, and aspects of the invention will be described in detail below with reference to the drawings.

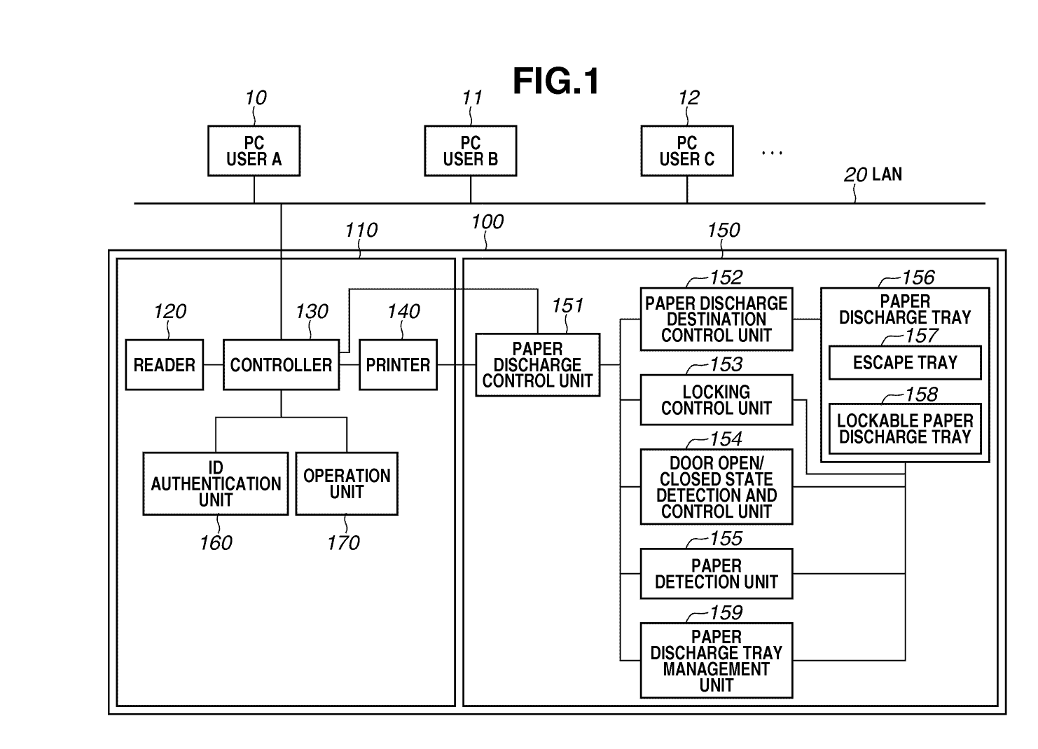

FIG. 1 is a block diagram exemplifying an image processing system including an image processing apparatus according to a first exemplary embodiment of the present invention. The image processing system uses a digital multifunction peripheral as the image processing apparatus, to which a plurality of information processing apparatuses (hereinafter, referred to as PCs) connected to a network is connected.

In FIG. 1, a digital multifunction peripheral 100 connects to PCs 10, 11, and 12 via a local area network (LAN) 20. The PCs 10, 11, and 12 are used by users A, B, and C, respectively. In this example, three PCs are described, but the number of PCs is not limited to three. Similarly, while one digital multifunction peripheral is illustrated in the drawing, the number of digital multifunction peripherals is not limited to one. In the present exemplary embodiment, a digital multifunction peripheral 100 is not limited to the digital multifunction peripheral and may be a printer.

Data is sent/received to/from the digital multifunction peripheral (hereinafter, referred to as the multifunction peripheral) 100 by a printer driver installed in the PCs 10, 11, and 12 via the LAN 20. Accordingly, data generated by a PC can be printed or the state of the multifunction peripheral 100 can be checked. The PCs 10, 11, and 12 are provided with hardware resources including a central processing unit (CPU), read only memory (ROM), and random access memory (RAM) and also with an external storage apparatus, input apparatus, and display apparatus, and a network controller is configured to be connectable to the LAN 20. The PCs 10, 11, and 12 perform data processing by executing applications after an operating system stored in the external storage apparatus is loaded into the RAM. The printer driver accepts a printing request by displaying a printing setting screen in the display apparatus in response to the printing request from an application. The printer driver is configured to be able to specify any of a plurality of lockable paper discharge units provided in the multifunction peripheral 100 for a generated print job. To share each lockable paper discharge unit by, for example, a plurality of users belonging to the same section, the multifunction peripheral 100 is configured to be able to record users allowed to use each lockable paper discharge unit in advance. Further, the multifunction peripheral 100 is configured to be able to discharge a printed sheet to one of the plurality of lockable paper discharge units based on an input print job.

The multifunction peripheral 100 includes a multifunction peripheral body 110 and a paper discharge unit 150. The multifunction peripheral body 110 mainly includes a reader 120 that reads a document image, a controller 130 that controls the whole apparatus, and a printer 140 that does printing on a sheet. Further, the multifunction peripheral body 110 includes an ID authentication unit 160 that authenticates a user and an operation unit 170 that specifies an operation of the multifunction peripheral 100.

The ID authentication unit 160 is used to perform user authentication and can read information stored in a device such as an IC card. The read data is compared with user information stored in an HD 139 or user information of a job being executed. According to a result thereof, use rights of the multifunction peripheral 100 are granted, various settings are made, or processing according to the job being executed is performed. Authentication can also be performed by face authentication using a camera (not illustrated) or other biometric authentication. The ID authentication unit 160 may be made to be able to read, in addition to IC cards, information from a mobile storage apparatus such as a mobile phone and personal digital assistance (PDA).

The operation unit 170 is a unit to make various settings of the multifunction peripheral 100. Communication data and display data are exchanged between an I/O controller 137 and the operation unit 170. Communication data is used to detect a key entered in the operation unit 170, and display data is used for the display in the operation unit 170.

The paper discharge unit 150 includes a paper discharge control unit 151 to control the whole paper discharge unit 150, communicate with the controller 130 and the printer 140, and control printed sheets.

A paper discharge tray 156 manages discharged sheets and is either a lockable paper discharge tray 158 capable of locking a door of the paper discharge unit and a paper discharge tray 157 without door and lock (hereinafter, referred to as an escape tray).

A paper discharge destination control unit 152 performs control of paper discharge according to the selection of the paper discharge destination of print sheets. A locking control unit 153 performs control of locking/releasing of the lockable paper discharge tray 158 based on an authentication result by the ID authentication unit 160. A door open/closed state detection and a control unit 154 detect opening/closing of the door of the lockable paper discharge tray 158 and also can control opening/closing of the door.

A paper detection unit 155 detects presence/absence of a sheet or sheets in the paper discharge unit and also checks whether the number of printed sheets exceeds the maximum number of loaded sheets. The paper discharge tray 156 is state-monitored and controlled by the locking control unit 153, the door open/closed state detection and control unit 154, and the paper detection unit 155. The paper discharge unit 150 also includes a paper discharge tray management unit 159.

The paper discharge destination control unit 152 determines attribute information of print data received from the PC 10, 11, or 12 and performs control to output to the lockable paper discharge tray 158 if the print data is a printing request whose security level is high with confidential information.

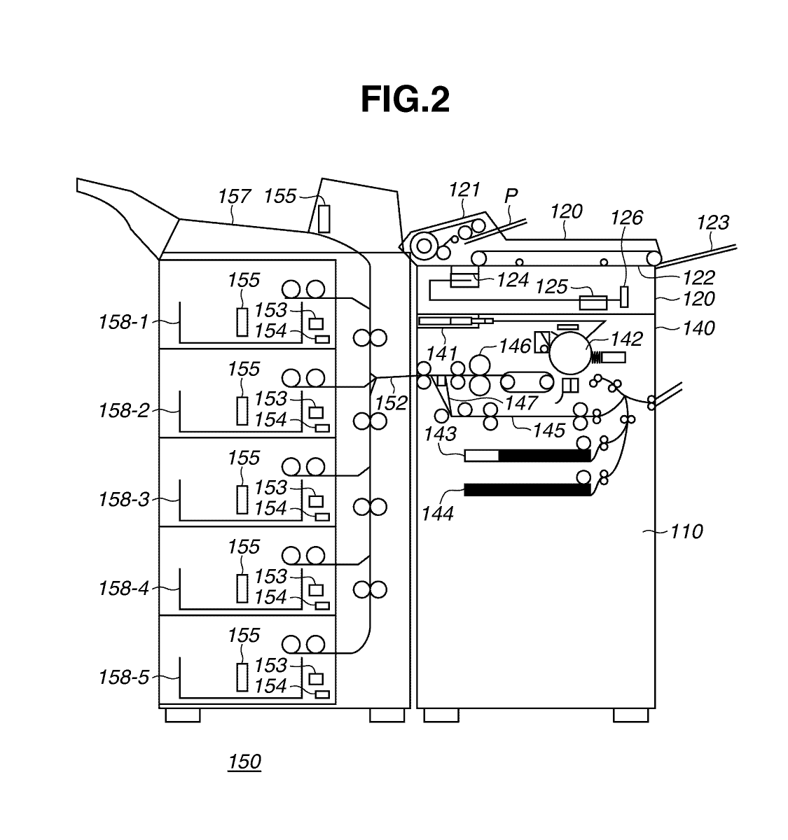

FIG. 2 is a sectional view illustrating an internal structure of the multifunction peripheral 100 illustrated in FIG. 1. The multifunction peripheral 100 in the present exemplary embodiment includes, as illustrated in FIG. 2, the reader 120, which reads a document image, the printer 140, and the paper discharge unit 150.

A document feeding apparatus 121, which automatically feeds a document, is mounted on the reader 120. The document feeding apparatus 121 feeds a document P set onto a document tray and pointing upward one by one from the first page in the left direction so that the document P is conveyed, after a curved path is passed through, on a platen glass 122 from left to right by passing over a flow reading position. Then, the document P is discharged to an outside paper discharge tray 123. When the document P passes the flow reading position on the platen glass 122 from left to right, the document image is read by a scanner unit 124 held at the position corresponding to the flow reading position.

When the document passes the flow reading position, the reading surface of the document is illuminated with light of a lamp of the scanner unit 124, and reflected light from the document is led to a lens 125 via a mirror. The light that passes through the lens 125 forms an image on an imaging surface of an image sensor 126.

Thus, by conveying the document in such a way that the document passes the flow reading position from left to right, a document reading scan is made. The whole document image is read by the image sensor 126, and the optically read image is converted by the image sensor 126 into image data before being output.

Predetermined processing is performed on the image data output from the image sensor 126 by the controller 130 before being input into an exposure control unit 141 of the printer 140 as a video signal. Here, the predetermined processing includes shading correction.

It is also possible to read a document by stopping the document at a predetermined position after being conveyed on the platen glass 122 by the document feeding apparatus 121 and causing the scanner unit 124 to scan the document from left to right in this state.

The exposure control unit 141 of the printer 140 modulates and outputs laser light based on the input video signal and the laser light is irradiated on a photosensitive drum 142 while being scanned by a polygon mirror or the like. An electrostatic latent image according to the scanned laser light is formed on the photosensitive drum 142.

The electrostatic latent image on the photosensitive drum 142 is made visible as a developer image by a developer supplied by a developing device. Sheet are fed from each of cassettes 143 and 144, a manual feeding unit, or a double-sided conveying path 145 in timing synchronized with the start of irradiation of laser light, and the sheet is conveyed to the photosensitive drum 142. The developer image formed on the photosensitive drum 142 is transferred onto the sheet.

The sheet onto which the developer image is transferred is conveyed to a fixing unit 146, and the fixing unit 146 causes the developer image to fix on the sheet with the sheet being heated under pressure. The sheet after being passed through the fixing unit 146 is discharged from the printer 140 toward the paper discharge unit 150.

When the sheet is discharged when an image formation surface thereof is directed downward (face down), the sheet after being passed through the fixing unit 146 is once led into an inversion path 147 by a switching operation of a flapper. After the back end of the sheet passes through the flapper, the sheet is caused to switch back before being discharged from the printer 140 by a paper discharge roller.

Hereinafter, this paper discharge mode will be called inversion paper discharge. The inversion paper discharge is performed when images are formed successively from the first page when, for example, images read by using the document feeding apparatus 121 are formed or images output from a computer are formed and the order of sheets after the paper discharge is the correct order of sheets.

Further, when double-sided recording in which images are formed on both sides of a sheet is set, the sheet is conveyed to the double-sided conveying path 145 after being led to the inversion path 147 by a switching operation of the flapper. Then, control is performed to re-feed the sheet led to the double-sided conveying path 145 to the photosensitive drum 142 in the aforementioned timing. The sheet discharged from the printer 140 is sent to the paper discharge unit 150.

The paper discharge unit 150 performs paper discharge processing to the paper discharge destination (tray). The paper discharge unit is divided into six trays, the tray 157 and paper discharge units 158-1 to 158-5, and the tray 157 is a released escape tray. On the other hand, each of the paper discharge units 158-1 to 158-5 is a lockable tray with a door. In the present exemplary embodiment, each of the paper discharge units 158-1 to 158-5 is configured to be usable by a plurality of users.

The sheet sent from the printer 140 to the paper discharge unit 150 is sent to a paper discharge unit by a flapper switched by the paper discharge destination control unit 152 according to the paper discharge destination determined from among six paper discharge destinations (trays) to select the route of the conveying path.

The sheet sent to the tray 157 or the paper discharge units 158-1 to 158-5 is successively piled up so that sheets sent earlier are positioned lower.

When sheets discharged to the paper discharge units 158-1 to 158-5 should be taken away, it is necessary to release the locking 153 of the lockable paper discharge tray 158 to open the door after authentication is performed by the ID authentication unit 160.

The sensor 155 to detect the remaining quantity of discharged sheets is arranged in each of the paper discharge units 158-1 to 158-5. Further, the door open/closed state detection and control unit 154 can detect opening/closing of the door, in addition to opening/closing control of the door.

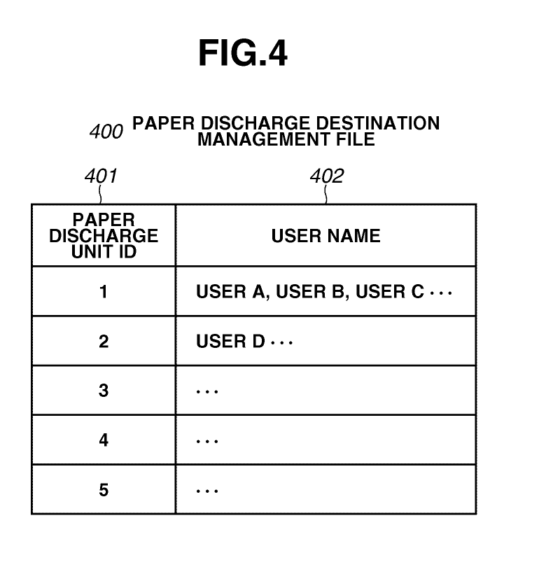

The paper discharge tray management unit 159 manages which lockable paper discharge tray 158 each user uses by outputting confidential documents to the tray. When a user sends a confidential document to the lockable paper discharge tray 158, the paper discharge tray management unit 159 determines to which tray of the paper discharge units 158-1 to 158-5 the document should be discharged by referring to content of a paper discharge destination management file 400 described below and illustrated in FIG. 4. In the description that follows, the lockable paper discharge tray 158 will be denoted when the paper discharge units 158-1 to 158-5 are generically called.

In the present exemplary embodiment, an example in which the lockable paper discharge tray 158 is determined in advance for each user is shown, but the paper discharge tray management unit 159 may dynamically allocate the lockable paper discharge tray 158 or the user may explicitly specify the lockable paper discharge tray 158 to be used.

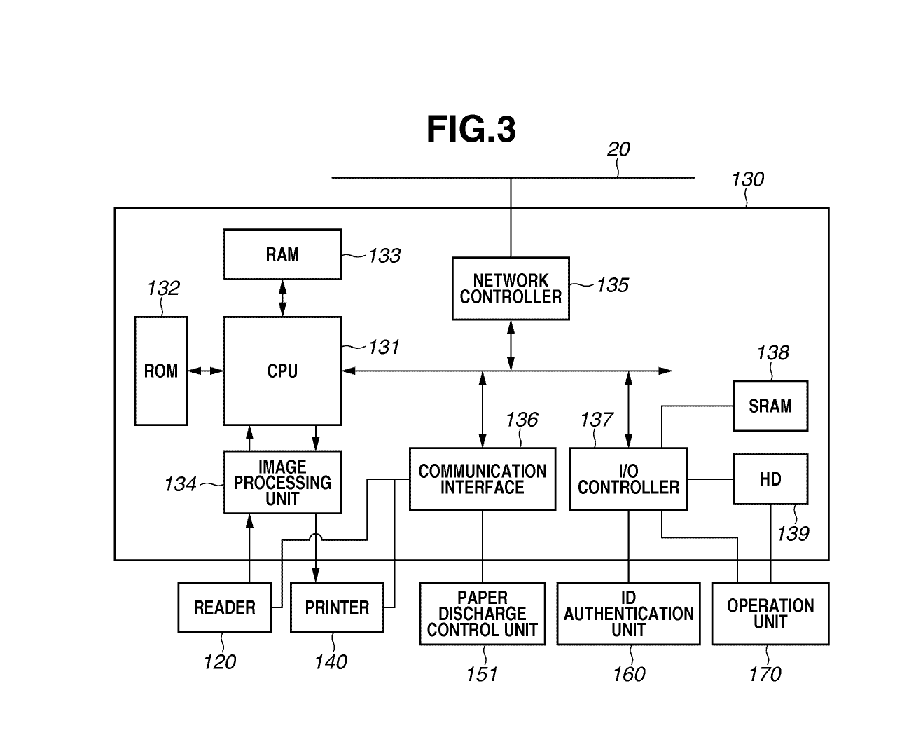

FIG. 3 is a block diagram illustrating the configuration of the controller 130 illustrated in FIG. 1. The description of the same reference numerals as those in FIG. 1 is omitted.

In FIG. 3, a CPU 131 controls the whole multifunction peripheral 100 and is a controller IC containing a CPU core and an image processing block. A RAM 133 is a system work memory to enable operation of the CPU 131 and is also an image memory to temporarily store image data. A ROM 132 is a boot ROM and has a boot program to start up the system stored therein. The CPU 131 is connected to a network controller 135, the I/O controller 137, and a communication interface 136 via a system bus capable of transmitting/receiving communication data and image data at high speed.

The network controller 135 is a controller to transmit/receive data by being connected to the LAN 20. The network controller 135 enables communication with PCs and external apparatuses connected to the LAN 20 and flexible input/output of image data and device information.

The I/O controller 137 is used to control various I/O devices. The CPU 131 can control the HD 139, the ID authentication unit 160, and the operation unit 170 via the I/O controller 137.

A hard disk drive (HD) 139 stores system software, image data, system management data, and box management data. A static random access memory (SRAM) 138 is a memory backed up by a battery and can hold various kinds of set data of the controller 130.

An image processing unit 134 performs various kinds of image processing such as reduction, enlargement, and luminance-density conversion of an image. The image processing unit 134 includes an image processing portion for input image data from the reader 120 and an image processing portion for output image data to the printer 140.

Image data read by the reader 120 is input into the CPU 131 via the image processing unit 134 before being temporarily stored in the RAM 133. The CPU 131 internally has a block that performs compression, decompression, and rotation processing of an image and can perform each piece of processing by accessing image data stored in the RAM 133.

Image data on which compression processing has been performed is transferred to the HD 139 via the I/O controller 137 and stored therein. Image data stored in the HD 139 is read by the CPU 131 and can be used to form an image on a sheet by the printer 140 after decompression processing being performed thereon.

Data can be transmitted to an external apparatus connected to the LAN 20 via the network controller 135. Image data read by the reader 120 is image-processed via the image processing unit 134 before being output to the printer 140. Communication processing at that point is performed via the communication interface 136. The communication interface 136 performs communication also with the paper discharge control unit controller 151 to instruct control of the paper discharge unit.

Print data by the PCs 10 to 12 via the LAN 20 is input into a receive buffer of the RAM 133 via the network controller 135 and the CPU 131. A raster image processor block (RIP) inside the CPU 131 rasterizes print data made up of received Page Description Language (PDL) code to a bitmap image on the RAM 133. The image data rasterized on the RAM 133 is transferred to the printer 140 to form an image on a sheet.

Data received via the network controller 135 can not only be printed, but also be stored in the HD 139 or transmitted to an external apparatus. The printer 140 has a plurality of feeding stages so that different sheet sizes or sheet orientations can be selected and includes corresponding sheet cassettes.

The sheet on which an image is formed by the printer 140 is sent to the paper discharge unit 150 to be discharged to either the lockable paper discharge tray 158 or the escape tray 157.

FIG. 4 is a diagram exemplifying the paper discharge destination management file 400 managed by the multifunction peripheral 100 illustrated in FIG. 1.

In FIG. 4, the paper discharge destination management file 400 is a file that stores information about, when some user sends a confidential document to the lockable paper discharge tray 158, to which of the lockable paper discharge trays 158-1 to 158-5 the document should be discharged. Content of the paper discharge destination management file 400 is set by the administrator in advance and is stored in the SRAM 138 or the HD 139 of the multifunction peripheral 100.

A column 401 indicates the paper discharge unit ID, and paper discharge unit IDs 1 to 5 are associated with the lockable paper discharge trays 158-1 to 158-5, respectively.

A column 402 indicates the user name, and the names of users who use the paper discharge tray are set for each of the IDs 1 to 5. In the present exemplary embodiment, for example, users A, B, C, and the like are set as users who use the lockable paper discharge tray 158-1 corresponding to the paper discharge unit ID 1.

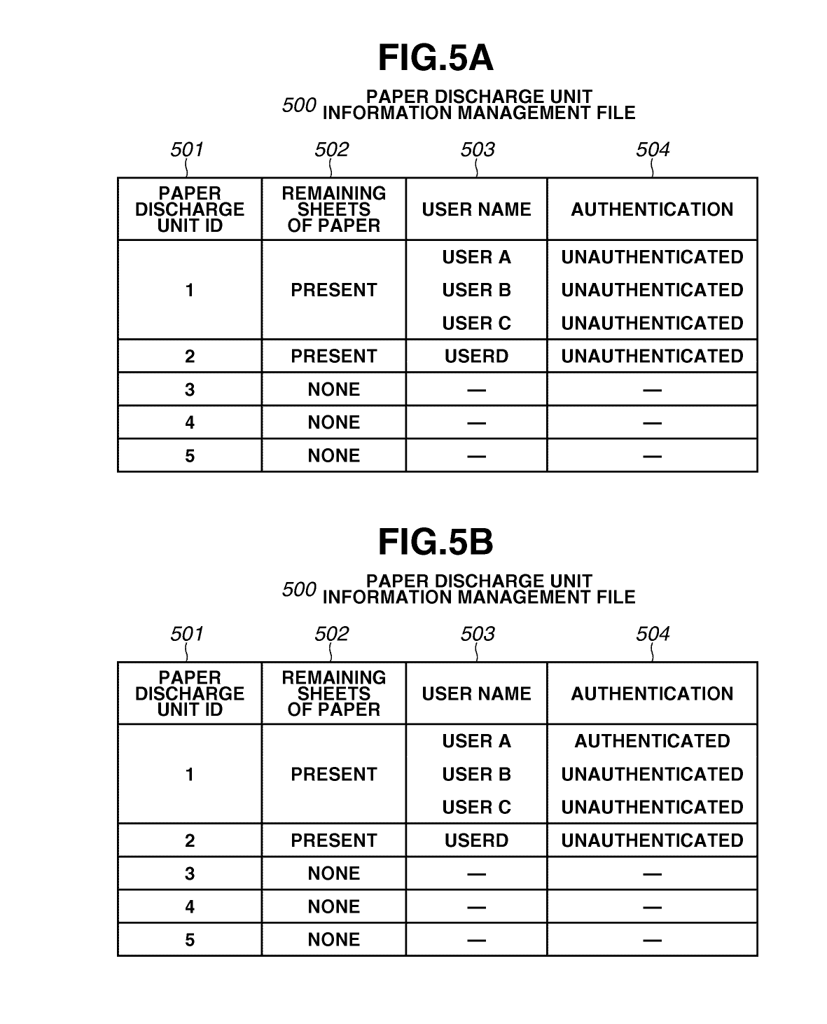

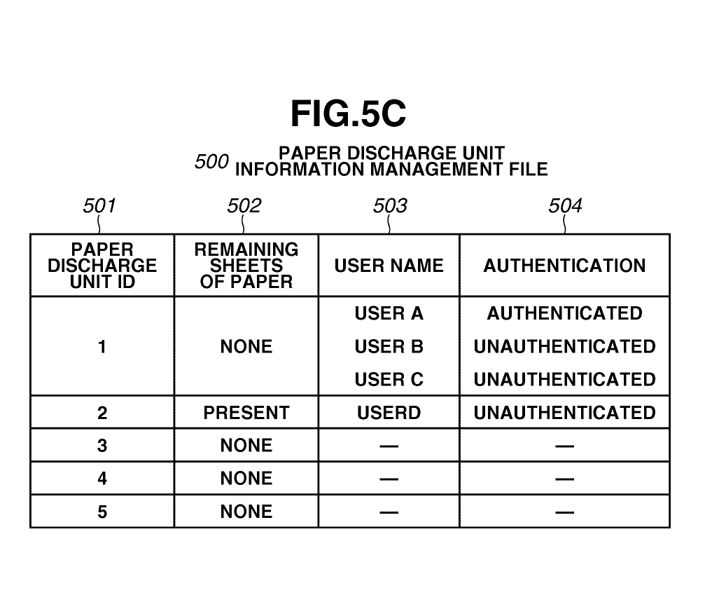

FIG. 5A is a diagram exemplifying a paper discharge unit information management file 500 managed by the multifunction peripheral 100 illustrated in FIG. 1.

In FIG. 5A, a column 501 indicates the paper discharge unit ID, and the paper discharge unit IDs 1 to 5 are associated with the lockable paper discharge trays 158-1 to 158-5, respectively. A column 502 indicates remaining sheets and represents information about presence/absence of remaining sheets for each of the lockable paper discharge trays 158-1 to 158-5.

A column 503 indicates the user name and represents users whose printed product is discharged to the lockable paper discharge tray for each of the lockable paper discharge trays 158-1 to 158-5.

A column 504 indicates user authentication information and represents authentication information of users set to the column 503. “Unauthenticated” is set to the user who has not been authenticated by the ID authentication unit 160 of the multifunction peripheral 100. On the other hand, “Authenticated” is set to the user who has been authenticated by the ID authentication unit 160 of the multifunction peripheral 100. “Authenticated” set to the column 504 indicates that the user has performed a taking-out operation of his (her) printed product. Similarly, “Unauthenticated” set to the column 504 indicates that the user has not performed a taking-out operation of his (her) printed product. In this manner, the paper discharge unit information management file 500 manages status information of each paper discharge unit.

FIG. 5A illustrates, as a specific example, content of the paper discharge unit information management file 500 in circumstances when printed products of the users A, B, and C are mixed on the lockable paper discharge tray 158-1. Thus, “Present” indicating that a printed product is present as remaining sheets of the column 502 are set for the paper discharge unit whose paper discharge unit ID in the column 501 is “1”. Then, “users A, B, and C” are set to the column 503. Further, it is assumed here that none of the users A, B, and C has been authenticated by the ID authentication unit 160 of the multifunction peripheral 100 and has taken out his (her) printed product. Thus, this situation corresponds to a state in which “Unauthenticated” is set to all users in the column 504.

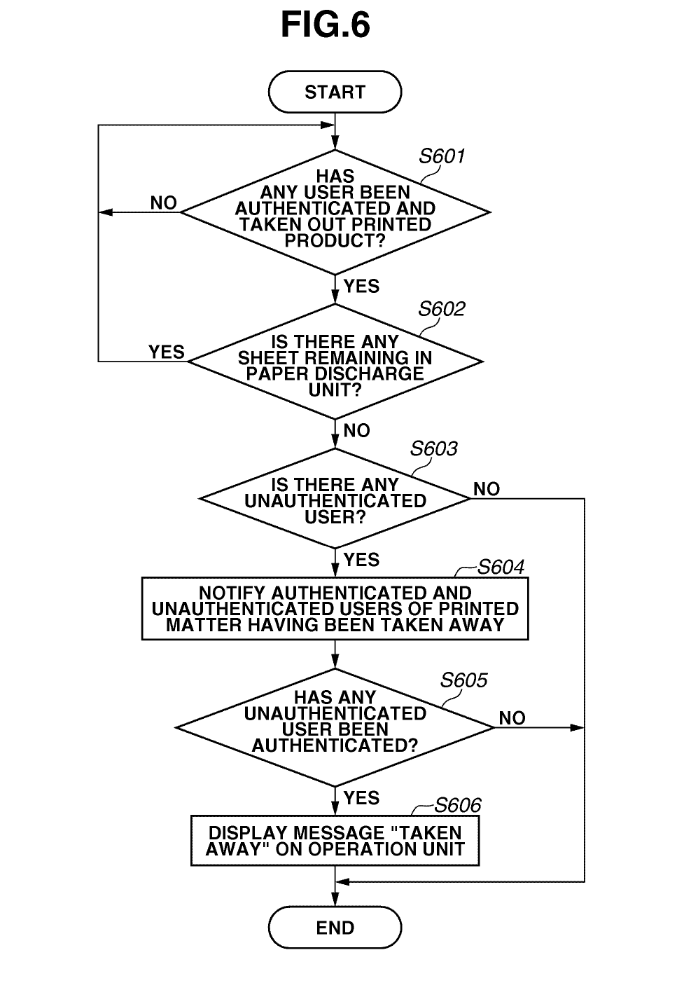

FIG. 6 is a flow chart exemplifying a data processing procedure in the image processing apparatus according to the exemplary embodiment of the present invention. This example is a processing example when taking out of a printed product by another user occurs in the multifunction peripheral 100 illustrated in FIG. 1. The control procedure corresponding to each step is stored in the ROM 132, the SRAM 138, or the HD 139 of the multifunction peripheral 100 and executed by the CPU 131. The flow of detection and notification processing of taking out by another user of a printed product in the multifunction peripheral 100 will be described below.

Here, a case where the user A mistakenly takes out printed products of the users B and C in paper discharge circumstances described with reference to FIG. 5A, that is, circumstances in which printed products of the users A, B, and C are mixed on the lockable paper discharge tray 158-1 will be described as a specific example.

First in step S601, the CPU 131 of the multifunction peripheral 100 waits, concerning the lockable paper discharge tray 158-1, until authentication and taking-out of a printed product by one of the users A, B, and C occur. For example, after performing authentication of a user by the ID authentication unit 160, the CPU 131 releases locking of the lockable paper discharge tray 158-1 to which the printed product of the user has been discharged. Accordingly, the controller 130 determines that taking out of sheets by the user has occurred. If, in addition to user authentication, the paper detection unit 155 detects a change in quantity of sheets discharged to the lockable paper discharge tray 158-1, the controller 130 may determine that taking out of sheets by the user has occurred. It is assumed here that the user A is authenticated by the ID authentication unit 160, then releases the locking 153 of the lockable paper discharge tray 158 to open the door, and takes out the printed product from the lockable paper discharge tray 158-1. At this point, it is assumed that the user A does not become aware that printed products of the users B and C are also mixed on the lockable paper discharge tray 158-1 and takes all of the printed products away.

Then, in step S602, after the door is closed by the user A and taking-out of the printed product is completed, the multifunction peripheral 100 detects presence/absence of a printed product on the lockable paper discharge tray 158-1 via the paper detection unit 155. If the CPU 131 determines that there is a still remaining printed product, the CPU 131 returns to step S601 to wait until authentication and taking-out of the printed product by still another user occur.

In this example, however, the user A has taken away all of the printed products on the lockable paper discharge tray 158-1 and thus, absence of printed products is detected.

In step S602, if the CPU 131 determines that absence of sheets is detected, the CPU 131 proceeds to step S603. Then, in step S603, the CPU 131 further determines whether there is any unauthenticated user who has not taken out his (her) printed product.

If the CPU 131 determines that no unauthenticated user is present, the CPU 131 determines that taking out of the printed product by another user has not occurred, and immediately terminates the flow chart.

In this example, however, it is apparent from content of the paper discharge unit information management file 500 that the users B and C have not been authenticated. At this point, even though the users B and C have not come to take out the printed products after the printed products are discharged to the lockable paper discharge tray 158-1, there remains no printed product on the lockable paper discharge tray 158-1. From the above fact, the CPU 131 can determine that taking out of the printed product by another user has occurred.

Therefore, in step S604, the multifunction peripheral 100 transmits an e-mail to the authenticated user and unauthenticated users to notify that taking out of the printed product by another user has occurred.

In this case, an e-mail indicating the possibility that the recipient may have mistakenly taken away the printed products of other users (in this example, the users B and C) is transmitted to the authenticated user (in this example, the user A) who is considered to have carried out taking-out by another user. Mail addresses to transmit an e-mail to each user may be stored in the HD 139 in advance.

On the other hand, an e-mail indicating the possibility that another user (in this example, the user A) may have mistakenly taken away the printed products is transmitted to unauthenticated users (in this example, the users B and C) whose printed products have already been taken away. Accordingly, the fact that mutual mix-up of printed products has occurred is set to the lockable paper discharge tray 158-1 and all users who have not taken out printed products are notified of the fact. However, the users A to C are users who share the lockable paper discharge tray 158-1. Thus, the users can then make contact with each other and, for example, the user A and the users B and C can exchange printed products needed by each user by hand.

It is further assumed here that the user B comes to the front of the multifunction peripheral 100 and causes the ID authentication unit 160 to authenticate himself (herself) without being aware of the notification.

Next, in step S605, when the CPU 131 of the multifunction peripheral 100 detects that authentication by an unauthenticated user has occurred, the CPU 131 proceeds to step S606. In step S606, the CPU 131 displays a message “Printed product of another user may also be taken out” in the operation unit 170 before terminating the flow chart. Alternatively, since the user who has operated the lockable paper discharge tray may have already left the place, the CPU 131 may terminate the flow chart after displaying a message “Printed product may have already been taken away by another user”. In any case, in step S606, it is useful to display a message indicating that there is a possibility that an error has occurred in taking out of a printed product. Alternatively, the taking-out time of the user A, the authentication time of the user B, and a difference therebetween may be calculated to display the elapsed time thereof together on the display unit 170.

On the other hand, in step S605, if the CPU 131 determines that no authentication by an unauthenticated user has occurred, the CPU 131 immediately terminates the processing flow.

FIGS. 5B and 5C are diagrams exemplifying the paper discharge unit information management file 500 managed by the multifunction peripheral 100 illustrated in FIG. 1. This example illustrates content of the paper discharge unit information management file 500 immediately after the user A logs in step S601 illustrated in FIG. 1.

As a difference of content from the paper discharge unit information management file 500 illustrated in FIG. 5A, the setting field of the column 504 corresponding to the user A is changed to “Authenticated” in FIG. 5B because authentication of the user A is performed in step S601. Concerning other content, there is no change from the point in time of FIG. 5A.

Similarly, FIG. 5C illustrates content of the paper discharge unit information management file 500 immediately after absence of a printed product remaining on the lockable paper discharge tray 158-1 is detected in step S602. In FIG. 5C, the setting field of remaining printed product information illustrated in the column 502 is further changed to “None”. Thus, in the image processing apparatus according to the present exemplary embodiment, the user authentication state, username, and presence/absence of sheets are associated and stored for each lockable paper discharge tray.

In step S603, the CPU 131 of the multifunction peripheral 100 refers to content of the paper discharge unit information management file 500 illustrated in FIG. 5C. Accordingly, the CPU 131 can detect the possibility of an occurrence of a printed product being taken away by another user in the lockable paper discharge tray 158-1. Here, more specifically, the CPU 131 can detect that the authenticated user A may have taken away printed products of the unauthenticated users B and C.

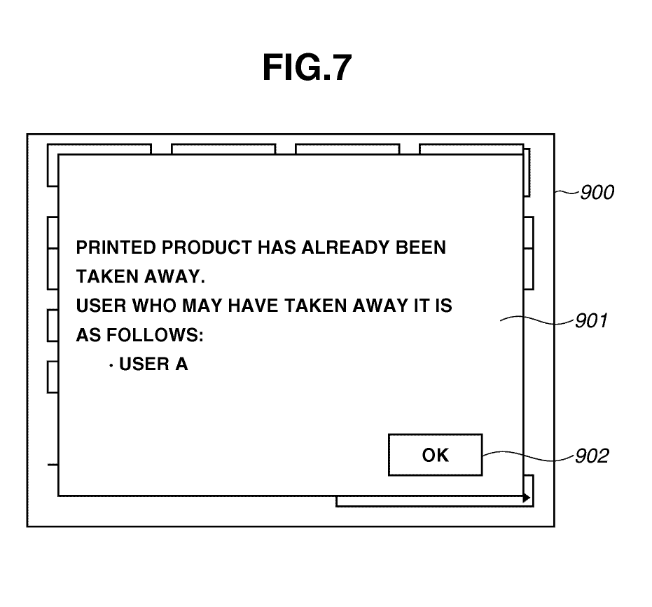

FIG. 7 is a diagram exemplifying a user interface displayed on the operation unit 170 illustrated in FIG. 3. In step S606, this example corresponds to an example of a message displayed on the operation unit 170 of the multifunction peripheral 100.

In FIG. 7, an operation screen 900 is a basic operation screen displayed on the operation unit 170 of the multifunction peripheral 100 when the user B is authenticated. A message screen 901 is a message screen displayed on top of the operation screen 900 displayed only when a user (the user B or the user C) whose printed product has already been taken away by another user is authenticated.

In the message screen 901, a message indicating that the printed product of the user B has already been taken away by another user is displayed, and the name of the user of the authenticated user at that point as a user possible who could have taken the printed product away, or the user A, are displayed under the control of the CPU 131.

A button 902 is used to cause the termination of the display of the message screen 901. When the user presses the button 902, the display of the message screen 901 is terminated, and only the operation screen 900 is displayed on the operation unit 700.

According to the present exemplary embodiment, if taking out of a printed product by another user occurs in an environment in which one paper discharge unit is shared by a plurality of users, involved users are notified of taking-out. Accordingly, the user who has taken out the printed product and users whose printed products have already been taken away can be made aware of the taking-out.

Moreover, circumstances in which whereabouts of printed products of users is unknown can thereby be prevented. Further, since such a notification is received only after taking-out by another user actually occurs, circumstances in which unnecessary notifications are frequently received by users can be prevented.

In the first exemplary embodiment described above, processing to make involved users aware of taking-out by another user by making a notification to the involved users when some user mistakenly takes away all of printed products of other users is described.

In this case, however, if some user takes away only a portion of printed products of other users, instead of all of the printed products of other users, the notification is not made, and users whose printed products have been taken away may be at a loss without knowing where their printed products are.

Thus, the multifunction peripheral 100 described in the first exemplary embodiment may further be configured to leave paper discharge unit information as a history when printed products of a plurality of users are mixed on the lockable paper discharge tray 185 so that the users can check the history later.

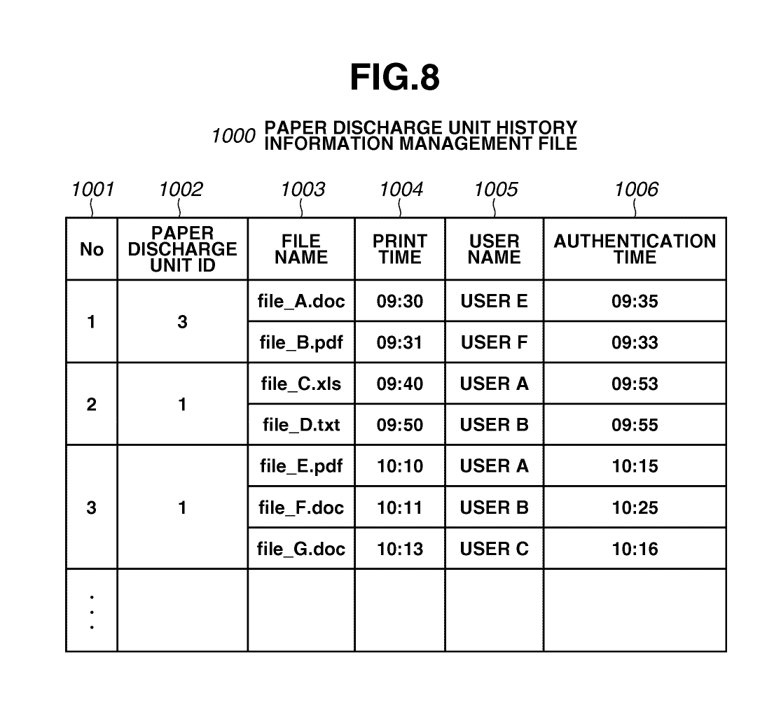

FIG. 8 is a diagram exemplifying a paper discharge unit history information management file 1000 managed by the multifunction peripheral 100 illustrated in FIG. 1.

In FIG. 8, a column 1001 indicates the number allocated to manage each piece of history information in the management file.

A column 1002 indicates the paper discharge unit ID of the paper discharge tray where mixing of printed products has occurred. The paper discharge unit IDs 1 to 5 correspond to the lockable paper discharge trays 158-1 to 158-5, respectively. A column 1003 indicates the names of files for which mixing of printed products has occurred. A column 1004 indicates the time when a printed product for the file indicated in the column 1003 has been discharged.

A column 1005 indicates the user name of the file indicated in the column 1003. A column 1006 indicates the time when the user indicated in the column 1005 has been authenticated by the ID authentication unit 160 of the multifunction peripheral 100.

The paper discharge unit history information management file 1000 illustrated in FIG. 8 illustrates, as an example, an occurrence of three cases No. 1 to 3 of printed product mixing. First, No. 1 shows an occurrence of mixing of a file “file_A.doc” of a user E and a file “file_B.pdf” of a user F on the lockable paper discharge tray 158-3 corresponding to the paper discharge unit management ID 3.

No. 2 shows an occurrence of mixing of a file “file_C.xls” of the user A and a file “file_D.txt” of the user B on the lockable paper discharge tray 158-1 corresponding to the paper discharge unit management ID 1.

Similarly, No. 3 shows an occurrence of mixing of a file “file_E.pdf” of the user A, a file “file_F.doc” of the user B, and further a file “file_G.doc” of the user C on the lockable paper discharge tray 158-1.

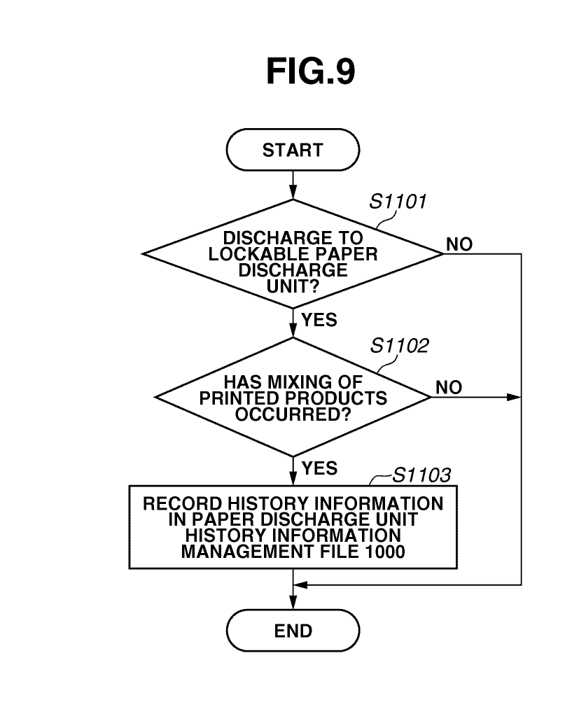

FIG. 9 is a flow chart exemplifying a data processing procedure in an image processing apparatus according to a second exemplary embodiment of the present invention. This example is a processing example of registration of paper discharge unit history information in the multifunction peripheral 100 illustrated in FIG. 1. The control procedure corresponding to each step is stored in the SRAM 138 or the HD 139 of the multifunction peripheral 100 and executed by the CPU 131.

In step S1101, when print data is received from any user, the multifunction peripheral 100 starts the flow chart. First, the CPU 131 determines whether to discharge the print data to the lockable paper discharge tray 158. If the CPU 131 determines that the print data should not be discharged to the lockable paper discharge tray 158, the CPU 131 immediately terminates the flow chart.

On the other hand, in step S1101, if the CPU 131 determines that the print data should be discharged to the lockable paper discharge tray 158, the CPU 131 proceeds to step S1102.

Then, in step S1102, the CPU 131 determines whether a printed product of another user is present on the lockable paper discharge tray 158 corresponding to the user. More specifically, the CPU 131 executes the user's job and stores information about to which lockable paper discharge tray a printed product of which user is discharged each time a printed product printed by executing the job is discharged. Then, in step S1102, the CPU 131 can make a determination based on the stored information. If the CPU 131 determines that such printed product is not present, the CPU 131 immediately terminates the flow chart.

On the other hand, in step S1102, if the CPU 131 determines that a printed product of another user is present, then in step S1103, the CPU 131 registers the paper discharge history information in a paper discharge unit history information management file 1100. Then, after performing the above processing, the CPU 131 terminates the flow chart.

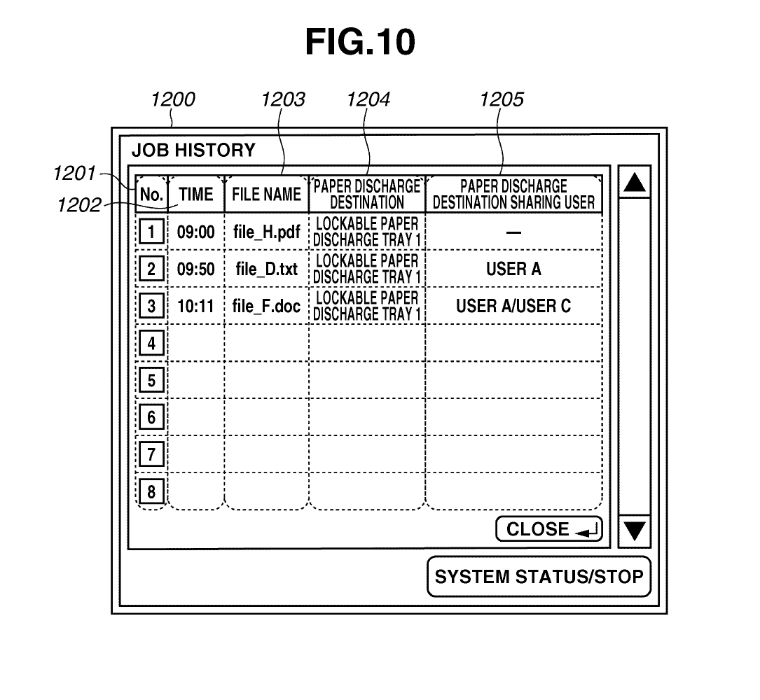

FIG. 10 is a diagram exemplifying a paper discharge unit history information management file 1200 managed by the multifunction peripheral 100 illustrated in FIG. 1. This example corresponds to a state in which after a user requests the display of job history, for example, the job history screen 1200 of the user B is displayed on the operation unit 170 of the multifunction peripheral 100. The job history screen 1200 is displayed after the user B is authenticated by the ID authentication unit 160 of the multifunction peripheral 100. A transition from the operation screen 900 illustrated in FIG. 7 can occur. In this example, the paper discharge control unit controller 151 illustrated in FIG. 1 performs paper discharge history information management processing to hold the paper discharge unit history information management file 1000 illustrated in FIG. 10 in the SRAM 138 or the HD 139 in the controller 130 for management.

In FIG. 10, a column 1201 indicates the number allocated to uniquely manage each piece of job history information of the user B. A column 1202 indicates the time of paper discharge execution. A column 1203 indicates the discharged file name. A column 1204 indicates the lockable paper discharge tray 158 that is a file paper discharge destination. A column 1205 indicates the names of users who have discharged printed products to the same lockable paper discharge tray 158 in a period after the file indicated in the column 1203 is discharged before the file is taken out by the user B.

In the present exemplary embodiment, first concerning the job history indicated as No. 1 in the column 1201, no file by another user is discharged in a period between discharging and taking-out so that no mixing of printed products has occurred.

Thus, the job information is not registered in the paper discharge unit history information management file 1000 illustrated in FIG. 8. Therefore, no other user name is set to the shared user field indicated by the column 1205.

On the other hand, concerning the job history indicated as Nos. 2 and 3, it is apparent from content of the paper discharge unit history information management file 1000 that mixing of printed products of the user A and the users A and C has occurred. Thus, “User A” and “User A/User C” are set to the shared user fields indicated by the column 1205, respectively.

For example, concerning the job (file_D.txt) indicated as No. 2 in the column 1201 in FIG. 10, it is assumed that the user B is authenticated by the ID authentication unit 160 of the multifunction peripheral 100 and when the user B takes out the printed product, the user B finds that the number of sheets thereof is insufficient. In that case, the user B knows the printed product of the user A was mixed in the same lockable paper discharge unit when file_D.txt was discharged, by referring to the job history 1200 in the operation unit 170. Thus, the user B can determine that probably the user A has mistakenly taken away a portion of file_D.txt together with his (her) printed product.

According to the present exemplary embodiment, when mixing of printed products of a plurality of users occurs on a lockable paper discharge tray, users are enabled to check later with whose printed product was mixed by leaving the relevant paper discharge unit information as a history. Thus, even though some user takes away only a portion of a printed product of another user, instead of all printed products, the user whose printed product is partially taken away can know who may have taken away from the history when the user finds that a portion of his (her) printed product is lacking.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-039174 filed Feb. 23, 2009, which is hereby incorporated by reference herein in its entirety.

What is claimed is:

1. An image processing apparatus that is capable of discharging sheets printed based on print jobs input by a plurality of users to a lockable discharging unit, comprising:
an authentication unit configured to authenticate the users;
a locking control unit configured to release locking of the lockable discharging unit according to an authentication result by the authentication unit;
a holding unit configured to hold status information indicating whether each of the plurality of users who have discharged sheets to the lockable discharging unit is authenticated by the authentication unit;
a determining unit configured to determine whether there is any user who is not authenticated by the authentication unit based on the status information held by the holding unit;
a detection unit configured to detect presence/absence of a sheet or sheets discharged to the lockable discharging unit; and
a notification unit configured to notify that an error has occurred in taking out of sheets if, after locking of the locked lockable discharging unit is released by the locking control unit, the detection unit detects that there is no sheet in the lockable discharging unit and the determining unit determines that there is a user who is not authenticated by the authentication unit.

2. The image processing apparatus according to claim 1, wherein when the authentication unit authenticates an unauthenticated user, the notification unit notifies that sheets which are be taken out by the unauthenticated user have been taken out by another authenticated user.

3. The image processing apparatus according to claim 1, further comprising:
a management unit configured to manage a history of discharged sheets for each lockable discharging unit when the detection unit detects that sheets printed based on the print jobs input by the plurality of users are discharged to the paper discharge unit; and
a display unit configured to display a paper discharge history managed by the management unit when the authentication unit authenticates an unauthenticated user.

4. The image processing apparatus according to claim 1, further comprising:
a plurality of lockable discharging units,
wherein the locking control unit releases locking of, among the plurality of lockable discharging units, a lockable discharging unit corresponding to the user authenticated by the authentication unit,
wherein the holding unit holds the status information indicating whether each of the plurality of users who have discharged sheets is authenticated by the authentication unit for each lockable discharging unit contained in the plurality of lockable discharging units,
wherein the determining unit determines whether there is any user who is not authenticated by the authentication unit for each lockable discharging unit contained in the plurality of lockable discharging units based on the status information held by the holding unit,
wherein the detection unit detects presence/absence of sheets discharged to each lockable discharging unit contained in the plurality of lockable discharging units, and
wherein the notification unit notifies that an error has occurred in taking out of sheets if, after the locking of the locked lockable discharging unit is released, the detection unit detects that there is no sheet in the released lockable discharging unit and the determining unit determines that there is a user who is not authenticated by the authentication unit for the released lockable discharging unit.

5. A control method for an image processing apparatus that is capable of discharging sheets printed based on print jobs input by a plurality of users to a lockable discharging unit, the control method comprising:
authenticating a user;
releasing locking of the lockable discharging unit according to an authentication result;
holding status information indicating whether each of the plurality of users who have discharged sheets to the lockable discharging unit is authenticated in a holding unit;
determining whether there is any user who is not authenticated based on the status information held in the holding unit;
detecting presence/absence of a sheet or sheets discharged to the lockable discharging unit; and
notifying that an error has occurred in taking out of sheets if, after locking of the locked lockable discharging unit is released, absence of a sheet or sheets in the lockable discharging unit is detected and presence of a user who is not authenticated is determined.

6. A computer-readable storage medium storing a computer program for an image processing apparatus that is capable of discharging sheets printed based on print jobs input by a plurality of users to a lockable discharging unit, the computer program comprising:
a code to authenticate a user;
a code to release locking of the lockable discharging unit according to an authentication result;
a code to hold status information indicating whether each of the plurality of users who have discharged sheets to the lockable discharging unit is authenticated in a holding unit;
a code to determine whether there is any user who is not authenticated based on the status information held in the holding unit;
a code to detect presence/absence of a sheet or sheets discharged to the lockable discharging unit; and
a code to notify that an error has occurred in taking out of sheets if, after locking of the locked lockable discharging unit is released, absence of a sheet or sheets in the lockable discharging unit is detected and presence of the user who is not authenticated is determined.
